(19) United States
(12) Patent Application Publication
(10) Pub. No.: US 2013/0129969 A1
(43) Pub. Date: May 23, 2013

(54) ELASTOMER STRUCTURE

(71) Applicant: Hans Liström, Saltsjo-boo (SE)

(72) Inventor: Hans Liström, Saltsjo-boo (SE)

(21) Appl. No.: 13/695,932

(22) PCT Filed: May 3, 2011
(86) PCT No.: PCT/SE2011/050551

§ 371 Date: Jan. 22, 2013

(30) Foreign Application Priority Data
May 3, 2010 (SE) 1000442.2

(51) Int. Cl. B32B 3/08

(52) U.S. Cl. CPC B32B 3/08
USPC 428/119

(57) ABSTRACT

A elastomer structure (10) for tyres or shoe soles, said elastomer structure (10) comprising:—an elastomer wear layer (11) comprising threads (12) being moulded into the wear layer (11),—and an adjacent cord layer (13), wherein the threads (12) in their longitudinal direction are arranged essentially perpendicular to the cord layer (13), characterized in that the threads (12) are attached inside the cord layer (13), the threads (12) each having two legs 16 going through a respective hole (17a) and (17b) in the cord layer (13) and extend longitudinally through the cord (13) to a wear surface (14) of the wear layer (11) and in that part of the legs (16) are wave-formed.

### FIELD OF THE INVENTION

The present invention relates to a elastomer structure for increasing the grip on icy or snow-covered road surfaces.

### BACKGROUND OF THE INVENTION

It is well known that spike tyres have an advantage in that they show a considerably lower slipering, better road contact and better grip than tyres without spikes on ice-covered roads. The beneficial effect of spike tyres on the winter safety of traffic has been irrefutably demonstrated.

But, it is also well known that increasing traffic load and spike tyres in combination have proven to be a remarkable road attrition factor. Because of that, in some countries this has even led to the prohibition of spike tyres, or to considerable restriction of using spikes tyres, for instance not on all streets and during a limited period of time.

Another drawback with conventional spike tyres is that the spikes fall out of the tyre during use, typically after a longer period of operational time, which strongly reduces the grip on ice-covered road surfaces. In worst case a spike coming loose might cause an accident.

Also a high disturbing noise is typical for spike tyres compared to tyres without spikes.

There have been a number of measures taken to try to solve this problem, but without being able to solve the problem, at least not en entirely. Thus, there has been a long-felt need to solve this problem.

There are also problems with shoe soles being slippery during winter conditions. Typically, spike plates that can be attached by strings or the like have been used to solve this problem. However, to attach and detach spike plates is time-consuming. Therefore, there is a need for a solution to this problem since long time.

### SUMMARY OF THE INVENTION

An object of the present invention is to provide an elastomer structure for tyres or shoes increasing the grip of on icy or snow-covered road surfaces. Another object of the present invention is to further develop a spike tyre structure that does decrease its road attrition properties or does not possess any other of the disadvantages listed above.

According to an aspect of the present invention, this is provided by an elastomer structure, for tyres or shoes, comprising an elastic wear layer comprising threads being moulded into the wear layer. The elastomer structure further comprises an adjacent cord layer. The threads are arranged in their longitudinal direction and are arranged essentially perpendicular to the cord layer.

The threads are attached inside the cord layer. The threads each has two legs going through a respective hole and in the cord layer and extend longitudinally through the cord to a wear surface of the wear layer and in that part of the legs are wave-formed.

The inventive elastomer structure is arranged to be provided as an outer layer on conventional vehicle tyres per se. The thickness of the layers of the inventive elastomer structure is designed depending on type of tyres. For instance, a car tyre typically requires of thickness of say 8-10 mm, whereas a truck tyre requires a thickness of say 15-20 mm. The other layers which are required for providing a vehicle tyre are of conventional type, except for the outermost layer.

The term “elastomer” includes natural and synthetic rubber, but also other kinds of polymers having elastomeric properties are included.

The term “inside” means the side directed to the part of the tyre filled with air or an inside of a shoe.

The term “essentially perpendicular” includes perpendicular, but also some degree of inclination.

The term “adjacent layer” means that the layers are stacked onto each other.

By the term “road surface” is meant any surface facing ground such as the wear surface of a wheel or a shoe sole.

The term “wave-shaped” includes, but is not limited to a sinusoidal shape.

By means of the inventive elastomer structure, the friction to the surface such as the road surface is substantially increased in relation to conventional rubber spike structures such as spike tyres or friction winter tyres without spikes. Also in relation to such structures being specifically designed in particular for icy weather conditions such as during the winter.

The elastomer structure is suitable for use in tyres for cars, lorries and lorries with trailer, construction vehicles, buses, etc. The braking strength is increased. The distance to stop a vehicle such as a car is much shorter, also on ice.

By means of the inventive elastomer structure, when provided in a vehicle tyre, the friction to the road surface is considerably higher also than with conventional rubber tyres. There are a few solutions proposed, but nothing has happened despite trials with special spikes and polymer bends trying to improve grip to the road surface. The friction will always be about the same as when new. There is no deterioration reducing friction as with conventional spikes when they are worn out.

It will be possible to use one tyre set during different seasons without changing tyre set between summer and winter tyres.

The threads typically have a Z-profile at a lower part of their legs. This hinders the threads from coming out of position.

The threads can be made of corrosion resistant material, such as stainless steel, or a nickel-alloy.

The threads can be made of plastics instead of metal. This is very beneficial as regards environmental aspects. Environmental aspects may also include low noise compared to conventional spike tyres. Tests have shown that increase of noise, typically up to 1.5 dB, is not even possible for a human ear to recognize, but can only be measured by sensitive instruments. Conventional spike tyres on the other hand, increase noise up to 30 dB, which is easy to hear also for a human ear.

Road handling is increased significantly in comparison to prior art tyres. Thinner profile can be used, which reduces the risk for aqua squid.

The inventive elastomer structure is also suitable for air planes, since take off and landing will be safer during winter conditions. In particular, the inventive elastomer structure is suitable for air plane wheels for landing on icy runways. The security is very much increased compared to conventional air plane wheels, which may be very slippery on icy runways.

### BRIEF DESCRIPTION OF THE DRAWING

The features and advantages of the present invention will become further apparent from the following detailed description and the accompanying drawing, of which:

FIG. 1 shows a side view of an elastomer structure, herein a rubber structure according to an embodiment of the present invention in cross-section;

FIG. 2 shows a front view of the rubber structure shown in FIG. 1 showing one of the threads, each having a Z-profile at a lower part of the leg of the thread;

FIG. 3 shows a side view of an alternative embodiment of the rubber structure shown in FIG. 1 comprising a thread having a sinusoidal structure; and

FIG. 4 shows a top view of the rubber structure of FIG. 1 comprising a thread having a trapes profile.

### DETAILED DESCRIPTION OF THE INVENTION

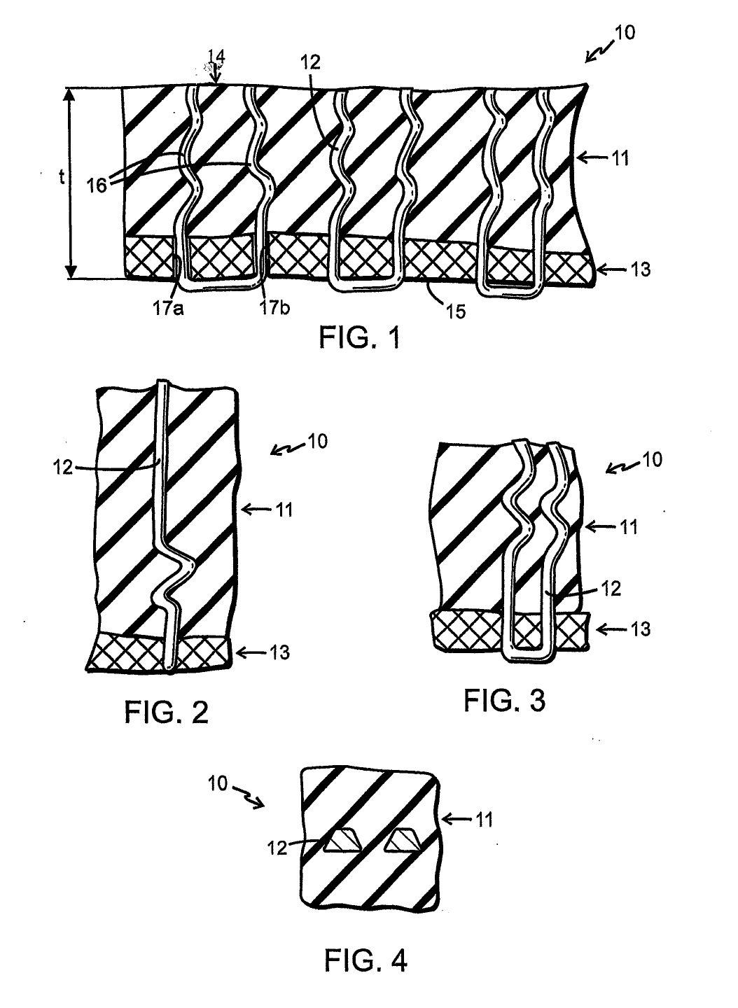

Referring now to FIG. 1, which shows a rubber structure according to an embodiment of the present invention, the principle of the present invention will be described as follows.

In FIG. 1 there is shown an embodiment of the present invention providing an elastomer, herein a rubber structure 10 for a rubber tyre for a vehicle such as a car. The rubber structure 10 can also be a rubber shoe sole or any other rubber structure demanding non-slipping on ice, even if FIG. 1 essentially shows part of a rubber tyre. The rubber structure 10 comprises a first layer being a rubber wear surface layer 11. The wear surface layer 11 comprises threads 12 that are arranged, typically moulded into the wear surface layer 11. The rubber structure 10 further comprises a second layer being a cord layer 13 adjacent to the first layer 11. The threads 12 in their longitudinal direction are arranged essentially perpendicular to the cord layer 13. The threads 12 are attached at an inside 15 the cord layer 13 and extend longitudinally through the cord layer 13 to the outside, the wear surface 14 of the wear surface layer 11. As is evident from FIG. 1 parts of the legs 16 are wave-formed, such as having sinusoidal profile (shown in FIG. 3).

The attachment of the threads 12 penetrating the cord 13 layer is provided on the inside 15 by means of the threads 12 being bent in a U-shape for instance having two legs 16 going through a respective hole 17a and 17b in the cord layer 13. The threads 12 are typically attached in a staple-like way. This is clearly shown in FIG. 1. By means of the attachment of the threads 12 being very firm, the threads 12 will unlikely be able to come loose at all. Since no spikes or high amount of metal comes loose, the amount of particles set free will be strongly reduced compared to conventional spike tyres of today as already briefly stated in the summary.

Since the threads 12 extend through the full thickness t of the cord layer 13 plus the wear surface layer 11, they will not be worn out before the rubber structure 10. This is a great advantage compared to conventional spike tyres, which often looses their spikes before the wear layer is worn out.

Typically, the threads 12 have a Z-profile supporting the travelling of the rubber structure 10 up and down, for instance a tyre during rotation. This is shown in FIG. 2 and, which shows a front view of the rubber structure comprising a thread having a Z-profile. The front view of FIG. 2 is shown rotated by 90 degree angle in relation to the side view of FIG. 1. The Z-profile also hinders the thread 12 from being pushed out of position. Also the angle of the Z-profile to the angle of the wave-form can be varied, but typically an angle (of direction) at about 90 degrees is suitable.

The wave-form of the threads have proven to be advantageous for holding the threads in position.

Typically, the threads 12 have a trapes profile. This is shown in FIG. 4, which shows a top view of the rubber structure comprising two threads having a trapes profile. This provides better stability in the rubber composition. Also other profiles similar to the trapes profile can be employed even though the trapes profile has proven to be suitable.

The rubber composition per se is typically of conventional type suitable for the application such as rubber tyres or rubber shoe soles. Also the composition of the cord-layer 13 is conventional per se. Steel-belt cord, as well as cords comprising plastics can be used depending on application. The cord layer 13 can be the outermost cord of an conventional tyre per se, or alternatively be an additional cord-layer on top of the conventional cord layer.

If the inventive elastomer structure is used for shoes, the cord layer is not necessary but can be exchanged for another layer.

Typically, the threads are made of corrosion resistant material such as stainless steel, or a nickel-alloy. Typically, a nickel alloy provides softer threads than chrome steel threads, which can be an advantage for some applications.

The threads can also be made of plastics, provided requirements as regards wear resistance etc are fulfilled.

Since no spikes or high amount of metal comes loose, the amount of particles set free will be strongly reduced compared to conventional spike tyres of today, where high amounts of particles causes serious troubles with environment problems. Moreover, the roads do not have to be treated with salt to reduce ice as often as with conventional tyres, provided the use of the inventive tyres is wide-spread.

The diameter of the threads 12 can be from 0.2 mm to 0.8 mm. The threads 2 can have a density of 1 to 3 per square millimetre or up to 7 per square centimetre.

The foregoing detailed description is intended to illustrate and provide easier understanding of the invention, and should not be construed as limitations. Alternative embodiments will become apparent to those skilled in the art without departing from the spirit and scope of the present invention.

1. An elastomer structure for tyres or shoe soles, said elastomer structure
comprising:
an elastomer wear layer comprising threads being moulded into the wear layer,
and an adjacent cord layer, wherein the threads in their longitudinal direction are arranged essentially perpendicular to the cord layer, characterized in that the threads are attached inside the cord layer, the threads each having two legs 16 going through a respective hole and in the cord layer and extend longitudinally through the cord to a wear surface of the wear layer and in that part of the legs are wave-formed.

2. The elastomer structure according to claim 1, wherein the threads also have a Z-profile a lower part of their legs.

3. The elastomer structure according to claim 1, wherein the threads in a cross-section have a trapets profile.

4. The elastomer structure according to claim 1, wherein the threads have a sinusoidal form profile.

5. The elastomer structure according to claim 1 wherein the threads are made of corrosion resistant material

6. The elastomer structure according to claim 5, wherein the threads are made of stainless steel, in particular nickel-alloy.

7. The elastomer structure according to claim 5, wherein the threads are made of plastics.

8. The elastomer structure according to claim 1 wherein the diameter of the threads are from 0.2 mm to 0.8 mm.

9. The elastomer structure according to claim 1 wherein the threads have a density of 1 to 3 per square millimeter or up to 7 per square centimetre.
